(19) United States
(12) Patent Application Publication
(10) Pub. No.: US 2026/0265465 A1
(43) Pub. Date: Sep. 10, 2026

(54) Method and System for Producing DeAlkalized Lignocellulosic Material and Bio-Based Products

(71) Applicant: Kevin Ryan BINGWA, Singapore (SG)

(72) Inventor: Kevin Ryan BINGWA, Singapore (SG)

(21) Appl. No.: 19/163,820

(22) PCT Filed: Mar. 8, 2024
(86) PCT No.: PCT/SG2024/050143

§ 371 Date: Sep. 9, 2025

(30) Foreign Application Priority Data
Mar. 10, 2023 (SG) 10202300665Y

(51) Int. Cl. C08H 8/00; B01D 11/02; B01J 19/00; B01J 19/10; B01J 19/12

(52) U.S. Cl. CPC C08H 8/00; B01D 11/0203; B01J 19/008; B01J 19/10; B01J 19/12

(57) ABSTRACT

The present invention describes an integrated system, apparatus and method for de-alkalizing lignocellulosic material and producing bioproducts. Particularly, the system produces de-alkalized lignocellulosic feedstock which can be used in various downstream bioproducts, such as formation of biofuel, biogas and biochemicals. Among others, the system comprises a slurry-making subsystem for combining lignocellulosic pre-treated particles with a water mixture comprise of water and a chemical agent to obtain a slurry; an ultrasonic treatment subsystem for the disruption of cellular structures, loosening of lignocellulosic matrix, removing and neutralizing alkali at the cellular level of the lignocellulosic material in the slurry; a hydrodynamic cavitation subsystem for high-shear mechanical breakdown of the lignocellulosic material at the cellular level in the slurry; and a direct steam injection subsystem in connection with the slurry-making subsystem and/or the hydrodynamic cavitation subsystem to achieve hydrostatic cavitation and alkali neutralization in the slurry.

### FIELD OF INVENTION

The present invention relates to the generation of de-alkalized bio-based products from de-alkalized lignocellulosic material. More particularly, the present invention relates to the development of a system and a method for converting lignocellulosic material into a broad range of usable bioproducts, including but not limited to solid fuels, biogas, biochemicals, and biomaterials. This mainly involves the de-alkalizing of lignocellulosic material and further downstream processes to convert the de-alkalized material into various forms of bio-based products.

### BACKGROUND

As the world seeks to reduce its dependence on fossil fuels and transition to a more sustainable energy mix, the potential of lignocellulosic material as a replacement for coal has garnered significant attention. Lignocellulosic material, a renewable energy source that is considered carbon neutral, can significantly reduce carbon emissions from power generation compared to coal. Moreover, the use of lignocellulosic material can contribute to increased energy security, rural development, and the promotion of sustainable development.

With recent technological advances in lignocellulosic conversion, including torrefaction, gasification, and pyrolysis, the production of high-quality solid, liquid, and gaseous fuels from de-alkalized lignocellulosic materials has become a feasible and attractive option for meeting the growing demand for energy while reducing greenhouse gas emissions.

By a lignocellulosic material is herein understood to refer to a class of materials that are primarily composed of lignin, cellulose, and hemi-cellulose, which are the main structural components of plants. These materials are derived from various types of lignocellulosic biomass, such as agricultural wastes, forestry residues, grasses, straws, bamboo, wood related products and dedicated energy crops, and waste paper and/or combinations of one or more of the above have attracted significant attention as a renewable and sustainable resource to produce bio-fuels, bio-products, and bio-chemicals.

Lignocellulosic materials are abundant, widely available, and have the potential to reduce the dependence on fossil fuels while minimizing the environmental impact of human activities. However, the raw cellulosic material cannot be used directly for production of energy or steel without pre-treat and thermal enhancements because of following reasons.

Firstly, the raw cellulosic materials have high alkali ash content. Lignocellulosic materials have higher ash content than fossil fuels that can cause fouling and corrosion in power and steel production equipment. The potassium and chlorine levels make raw and even enhanced biomass unusable for power and steel production today. Although, the efforts are done for removing alkali from the raw cellulosic materials However, the removal of ash content is critical to opening their use power and steel production.

Secondly, the raw cellulosic materials have high moisture content. The raw lignocellulosic materials typically have high moisture content that reduces their energy content and makes them difficult to transport and store. Thirdly, the raw lignocellulosic materials have a low energy density compared to fossil fuels such as coal and natural gas, which limits their use in power and steel production.

Fourthly, the lignocellulosic materials are composed of a complex mixture of cellulose, hemicelluloses, and lignin. These components create a rigid cell structure and have different properties and require different processing methods to extract their energy content and to make the material more available for enzymes. Lastly, the raw lignocellulosic materials have inconsistent quality due to variations in the species, age, and location of the trees or plants from which they are harvested.

As known in the prior-art, the plant cells are characterized by their rigid cell walls that remain intact even when the cell cytoplasm detaches under stress conditions. The plant cell walls and membrane prevents the osmotic movement of molecules and ions, such as potassium ions (K+), which are commonly found in plant cells.

As a result of plasmolysis or rupture of the cytoplasmic membrane from the cell wall, potassium ions and other ionized alkali materials remain confined within the cellular structures, including the organelles, vacuoles, and cytoplasmic structures that constitute the cell. These organelles retain the ionized materials and continue to function within the cytoplasmic stack of the cell. This property of plant cells is important to consider for designing a de-alkalizing system to understand the fundamentals of how alkali materials are distributed and stored within the cell.

Potassium ions (K+) are one of the major cations present in plant cells and are involved in various physiological processes such as osmoregulation, enzyme activation, and charge balance. In plant cells, potassium ions are primarily held in the cytoplasm and vacuole. The cytoplasm is the fluid-like substance that fills the cell and contains various organelles and structures. Potassium ions are attracted to negatively charged molecules in the cytoplasm, such as proteins and nucleic acids, and are often involved in enzymatic reactions.

The vacuole is a large, membrane-bound organelle that occupies a significant portion of the plant cell volume. The vacuole contains a variety of molecules, including water, sugars, amino acids, and inorganic ions, such as potassium. In fact, potassium is often the most abundant cations in the vacuole, where it plays a key role in maintaining turgor pressure and regulating cell volume. Potassium ions can also be found in the cell wall of some plant cells, where they contribute to the structural integrity of the cell wall and regulate cell expansion and or may act as a defense mechanism. However, the amount of potassium ions in the cell wall is generally much lower than in the cytoplasm and vacuole. Lignin and cellulose, the two major components of plant cell walls, do not typically contain significant amounts of potassium ions.

The movement of potassium ions and other alkali compounds through plant cell walls is limited by the rigid and complex structure of the cell wall itself. The cell wall is a rigid and complex structure composed of various polysaccharides, proteins, and other compounds, which act as a physical barrier to the free movement of molecules and ions. In addition, the cell wall has a net negative charge due to the presence of carboxylic and phenolic functional groups, which can repel positively charged ions such as alkali and potassium.

Furthermore, the movement of alkali ions through the cell wall is controlled by various transport proteins and channels that are embedded in the cell membrane. These transporters and channels regulate the influx and efflux of potassium ions, ensuring that the ion concentration within the cell remains within a certain range.

Traditional methods involve excessive chemical use, energy consumption, mass loss, and time frames, which are not only inefficient but also unsustainable. Prior-art system and methods have relied on techniques such as multiday soaking, counter current washing, and the use of expensive solvents. The existing prior art does not appear to have developed an apparatus that specifically meets all the requirements for de-alkalizing lignocellulosic material on a cellular level while minimizing energy, water, and chemical usage, as well as reducing lignin/cellulose loss, while ensuring high repeatability and scalability.

The existing prior art does not appear to have to create a continuous integrated high volume alkali removal system. The prior-art systems and methods have high levels of alkali in lignocellulosic can cause reduced heat transfer, increased emissions, slagging, corrosion, and reduced steel quality. The intricate molecular structure of lignocellulosic material poses a challenge in pre-treatment systems and processes, rendering it challenging to convert the material into useful bio-fuels, bio-gas, and bio-chemicals.

The known prior-art encounters difficulties in handling high volumes of low-density, moist and fibrous raw material that causes difficulties in hardening of the solid fuels to meet high Hargraves Grindability Index (HGI) specifications set by customers. Meeting the index requirements is essential for using lignocellulosic as a feedstock in existing coal-based processes. The current state of the art fails to provide an integrated system and method for pre-treating lignocellulosic and biomass material that effectively removes undesirable elements like alkali while also enhancing its suitability for a downstream process, such as, torrefaction, gasification, pyrolysis, enzymatic and chemical processes, to produce bio-gas, bio-fuels, solid bio-fuels, bio-chemicals and other sustainable products on a continuous basis. This invention addresses critical technical challenges within this field and provides innovative solutions that have not been fully addressed by existing technologies, making it a valuable and necessary contribution to the bio-energy field.

It is apparent now that numerous methods and systems are developed in the prior art that are adequate for various purposes. Furthermore, even though these inventions may be suitable for the specific purposes to which they address, accordingly, they would not be suitable for the purposes of the present invention as heretofore described. Thus, there is a need to provide a new integrated end-to-end system, method for producing a multi-purpose de-alkalized lignocellulosic feedstock.

### SUMMARY

The following presents a simplified summary to provide a basic understanding of the present invention. This summary is not an extensive overview of the present invention, and is not intended to identify key features of the invention. Rather, it is to present some of the inventive concepts of this invention in a generalized form as a prelude to the detailed description that is to follow.

The present invention seeks to provide a system, apparatus and a method capable of generating useful de-alkalized lignocellulosic material for one or more downstream processes, thereby facilitating conversion of lignocellulosic material and lignocellulosic waste into bio-products. More particularly, the system enables utilization of lignocellulosic material as a sustainable alternative to coal in the power and steel sectors, as well as to unlock novel sources of feedstock for the bio-fuels, bio-gas, bio-chemicals, and bio-products industries. For example, the system is able to de-alkalize lignocellulosic oil palm biomass and converting them into feedstock useful in production of fuel pellets.

The invention's integrated system and method combine advanced technology systems and process intensification to effectively tackle a complex set of issues that previously remained unsolved by the prior art. By integrating multiple unit operations and innovative technologies, process intensification optimizes chemical and industrial processes to achieve greater efficiency, productivity, and sustainability. As a result, the system delivers superior performance, effectively overcomes critical technical challenges, reduces waste and emissions, and enhances overall efficiency, reliability, and flexibility while minimizing its environmental impact.

The present invention seeks to provide a system, apparatus, and a method that targets cellular-level disintegration of lignocellulosic material cell walls, organelles, vacuoles, and cytoplasmic structures, combined with the use of steam to drive the osmotic potential of each cell, high-shear force, and high-pressure processing to remove alkali and ionic waste from each cell of the lignocellulosic material. The system offers a way to further loosen the complex structure of the de-alkalized material such that they are more accessible to a downstream process (such as, enzymes and biochemical treatment), hence providing a universal de-alkalized lignocellulosic feedstock adaptable to multiple downstream processes.

The present invention seeks to provide a system, apparatus, and a method which can process the lignocellulosic material in batch or in a continuous manner. In one embodiment, the present invention provides a scalable, continuous, low-chemical-usage system for removing 95% or more of alkali from lignocellulosic cells without reducing its lignin and cellulose content. It shall be understood that high levels of alkali in lignocellulosic material is undesirable as it can cause reduced heat transfer, increased emissions, slagging, corrosion, and reduced steel quality.

The present invention provides a system and method that preferably converts lignocellulosic material into particle form hence enabling a relatively better mixing and transportation through-out the system. Furthermore, particles having a reduced size have a relatively lower settling rate, reducing the likelihood of clogging or blockages in the system.

In one embodiment, the system for producing de-alkalized lignocellulosic material and bioproducts, comprising (a) a size reduction subsystem for processing lignocellulosic material into particles having a reduced size; (b) a pre-treatment subsystem employing electromagnetic frequency and electric field to pre-treat the particles; (c) a slurry-making subsystem for combining the pre-treated particles with a water mixture comprise of water and a chemical agent to obtain a slurry; (d) an ultrasonic treatment subsystem for the disruption of cellular structures, loosening of lignocellulosic matrix, removing and neutralizing alkali at the cellular level of the lignocellulosic material in the slurry; (e) a hydrodynamic cavitation subsystem for high-shear mechanical breakdown of the lignocellulosic material at the cellular level in the slurry; (f) a direct steam injection subsystem in connection with the slurry-making subsystem and/or the hydrodynamic cavitation subsystem to achieve hydrostatic cavitation and alkali neutralization in the slurry; (g) an automated testing subsystem for real-time monitoring and adjustment of de-alkalization processing conditions; (h) a separation subsystem for dividing the processed slurry into solid de-alkalized material and treated water; (i) a water recirculation and treatment subsystem that recirculates system-treated water and/or utilizes the treated water to produce bioproducts; (j) a slurry-pumping subsystem configured to generate positive pressure and high-shear cavitation throughout the system; and (k) a densification subsystem configured to convert the solid de-alkalized material into densified bioproducts.

The system is adaptable to a water-treatment plant by connecting to the water-recirculating subsystem, whereby the system takes up wastewater from the plant or discharge wastewater thereinto.

Preferably, the water mixture comprises water is fresh water and/or the recirculated water, and chemical agents bindable to alkali ions present in the pre-treated lignocellulosic material.

Preferably, the densification subsystem comprises a drying module, a mixing unit for binder and chemical agent addition to form heat resistant silicate compound upon contact with an alkali, and a densification device for compression of the solid de-alkalized material.

In one embodiment, the lignocellulosic material pre-treatment sub-system comprises: (i) a electromagnetic processing unit to breakdown lignocellulosic material in the particles at 100 MHz to 5000 MHz; and (ii) a pulsed electric field (PEF) processor connected to the electromagnetic energy processing unit so that the particles are further subjected to PEF at a 10 to 100 kV.

In one embodiment, the direct steam injection sub-system comprises: (i) a mixing vessel configured with a steam inlet, a slurry inlet and heated slurry outlet, wherein the slurry inlet pipe has a helical baffle insert and multiple steam jets, while the heated slurry outlet is configured to connect the flow-through hydrodynamic cavitation subsystem, in which upon operation the slurry and steam are blended together in the vessel by direct injection of steam into the slurry at a temperature up to 350° C. and under a pressure of up to 2 MPa; and (ii) a cooling system connected to the vessel to reduce the temperature of the slurry post to mixing.

In one embodiment, the ultrasonic treatment subsystem comprises: (i) an ultrasonic enabled reactor vessel comprising at least one ultrasonic device and a high-shear agitator having a rotor-stator assembly, wherein at least one of the ultrasonic devices is located in vicinity to the rotor-stator assembly to concentrate ultrasonic field emission around the rotor-stator assembly; (ii) at least one heating vessel configured to perform heating to the slurry prior and/or post to the ultrasonic enabled reactor vessel; (iii) at least one cooling vessel configured to perform cooling of the slurry to a temperature suitable for an ultrasonic treatment; and (iv) at least one ultrasonic flow cell located prior and/or post to the ultrasonic enabled reactor vessel, wherein the ultrasonic flow cell comprises a cylindrical flow through vessel including a helical insert and one or more ultrasonic devices.

In the present invention, the system comprises progressive cavity pumps and pressure relief valves.

Preferably, the ultrasonic enabled reactor vessel further comprises a supercritical fluid dispersion unit.

Advantageously, the system further comprises a collection subsystem configured to aggregate lignocellulosic material using a sensor-based identification system, whereby the sensor-based identification system is capable of distinguishing material based on type, conditions, and processing suitability.

Preferably, the collection subsystem comprises an artificial intelligence (AI)-enhanced digital management platform which integrates with an autonomous transport mechanism for efficient material collection and logistics management.

Advantageously, the pre-treatment subsystem further includes a microwave assisted extraction (MAE) system that integrates microwave and ultrasound technology.

Advantageously, the system further comprises a renewable energy subsystem for powering the de-alkalization process, wherein the renewable energy subsystem comprises a solar power module, a hydrogen fuel cell module, and a biomass conversion module, all managed by an AI-enhanced control unit.

Advantageously, the slurry separation subsystem further incorporates a sensor array module for monitoring of water quality and ionic waste concentration.

Advantageously, the system further comprises a thermal conversion subsystem connected to the densification subsystem for torrefaction and/or carbonization of the densified de-alkalized material, wherein the thermal conversion subsystem comprises a torrefaction module, a carbonization module, and a gaseous emission control module.

Advantageously, the system further comprises a biogas from the de-alkalized lignocellulosic material and treated water, wherein the biogas production subsystem includes a de-alkalized material treatment module, an anaerobic digester unit, and a biogas purification system.

Advantageously, the system further comprises a storage and transport subsystem for handling, storage, and transport of the lignocellulosic material, the de-alkalized lignocellulosic material, and the bioproducts obtained, wherein the subsystem utilizes a fleet of sustainable transport vehicles and a digital management platform for logistics optimization.

Advantageously, the system is adaptable to a carbon credits and renewable energy certificates (RECs) subsystem configured to generate carbon credits and RECs based on the reduction of greenhouse gas emissions and the sustainable operation of the de-alkalization process.

Advantageously, the system further comprises is adaptable to a renewable energy subsystem for powering the system using renewable energy sources, the renewable energy subsystem comprises a solar power module, a hydrogen fuel cell module, and a biomass conversion module.

In one embodiment, the present invention provides an apparatus for de-alkalinizing lignocellulosic material, comprising: apparatus for de-alkalinizing lignocellulosic material, comprising: (a) a cooling vessel configured to reduce temperature of the slurry from the second FTHC to a temperature of 2 to 20° C.; (b) a first set of ultrasonic flow cells, preferably incorporating a helical flow cell vessel insert configured to transfer the slurry from the cooling vessel to an ultrasonic enabled reactor vessel along a helical pathway, wherein the ultrasonic flow cell subjects the slurry to a pressure of 0.1 to 20 MPa at an ultrasonic frequency range of 10 MHz to 50 MHz; (c) one or more ultrasonic enabled reactor vessel comprising at least one ultrasonic device and a high-shear agitator having a rotor-stator assembly, wherein at least one of the ultrasonic devices is located in vicinity to the rotor-stator assembly to concentrate ultrasonic field frequency of 10 MHz to 50 MHz around the rotor-stator assembly; (d) a second set of ultrasonic flow cells, preferably incorporating a helical flow cell vessel insert configured to transfer the slurry from the cooling vessel to an ultrasonic enabled reactor vessel along a helical pathway, wherein the ultrasonic flow cell subjects the slurry to a pressure of 0.1 to 20 MPa at an ultrasonic frequency range of 10 MHz to 50 MHz; (e) a flow-through hydrodynamic cavitation (FTHC) unit configured to transfer the steam injected slurry while subjecting it to pressurization at about 0.1 to about 100 MPa thereby inducing hydrodynamic cavitation therein; (f) a direct steam injection device configured to inject steam into a lignocellulosic slurry at a temperature of up to 250° C. and pressure of up to 21 MPa; (g) a network of reactor conduits configured to transport the heated slurry therethrough under a pressure of up to 200° C. and pressures up 10 bars for a predetermined amount of time; and (h) a heating vessel configured receive slurry from the reactor conduits and further provide heating up to 200° C. and agitation thereof.

Preferably, the ultrasonic enabled reactor vessel further connects to a supercritical fluid source.

Preferably, the direct steam injection includes a cylindrical vessel with a helical baffle within the vessel inlet pipe.

Preferably, the ultrasonic enabled reactor vessel comprises a plurality of ultrasonic devices, each of them is positioned at the reactor in a manner to provide a uniform ultrasonic field in the reactor, in which one of them is positioned at bottom of the reactor.

Preferably, the high-shear agitator comprises a motor, a rotor shaft and a rotor-stator assembly, wherein the rotor shaft includes at least a rotor blade.

Preferably, the stator is configured with an extended skirt portion to connect with the ultrasonic device attached at the bottom of the reactor thereby transmitting ultrasonic emission from the ultrasonic device to the reactor.

Preferably, the high-shear agitator further comprises a stabilizing means with one side lying against the reactor and another side fastened to the stator thereby stabilizing the agitator.

Preferably, the stabilizing means is configured as a channel in connection with the supercritical fluid source.

Preferably, the stabilizing means connects to the skirt portion of the stator and distributes the supercritical fluid in the reactor.

In one embodiment, the present invention provides a method for producing de-alkalizing lignocellulosic material and bioproducts based on the system and method aforementioned, the comprising the steps of: (a) reducing the size of the lignocellulosic material into particles; (b) pre-treating the material using electromagnetic and electric field processes; (c) forming a slurry by mixing the pre-treated material with a water mixture comprising chemical agents; (d) subjecting the slurry to ultrasonic resonance and flow through cavitation in a pressurized environment with high-shear to induce hydrodynamic cavitation thereby cellular level disruption, enhancing extraction of alkali component from the slurry; (e) subjecting the slurry to flow through cavitation in a pressurized environment with high-shear to induce hydrodynamic cavitation; (f) subjecting the slurry to direct steam injection to induce hydrostatic cavitation in the presence of rapid heating and cooling of the slurry material to enhance alkali neutralization; (g) continuously monitoring and adjusting the process based on alkali levels; (h) separating the slurry into solid de-alkalized material and treated water; (i) washing the slurry to remove ionic waste and solid particles of larger than 1 micron from the slurry thereby obtaining a de-alkalized lignocellulosic material; (j) recirculating separated treated water from the application of the process or using the separated treated water to make bioproducts; and (k) subjecting the solid de-alkalized material to densification in order to produce a de-alkalized bioproducts.

In one embodiment, the method further comprises a step of collecting the lignocellulosic material, followed by washing, digesting and/or adding chemical agents to the collected lignocellulosic material before reducing them into particles.

Preferably, the step of (d) is conducted in the presence of supercritical carbon dioxide.

Preferably, the step of (d) is conducted under ultrasonic frequency range between 10 Hz to 50 MHz.

Preferably, the step of (a) comprises the steps of: processing lignocellulosic material into particles having an average particle size of less than 10 mm.

Preferably, the step of (b) comprises the steps of: (i) subjecting the particles to electromagnetic energy processing treatment at 500 to 5000 MHz; and (ii) subjecting the particles to pulsed electric field (PEF) provided by voltage pulses between 10 to 100 kV to obtain porous particles.

Preferably, the step of (c) has a water mixture-to-particles ratio of 1:1 to 1:25.

Preferably, the step of (f) is conducted heating the slurry with a direct steam injection at a temperature of 1° C. to 250° C. and a pressure of 0.01 MPa to 21 MPa.

Preferably, the water mixture comprises of water and/or recirculated water and, chemical agents bindable to alkali ions present in the pre-treated lignocellulosic material.

Preferably, the step of densification is conducted by drying and mixing the solid de-alkalized material with a binder and chemical agent, followed by compressing thereof.

Preferably, the step of (f) is conducted at a pressure of 0.1 MPa to 50 MPa.

Preferably, the rapid heating in the step of (f) is conducted at a pressure of 0.1 to 21 MPa and provides a heating rate of up to 250.

Preferably, the rapid heating step is conducted in the presence of inert gas to prevent oxidation of lignocellulosic material in the slurry.

Preferably, the rapid cooling in the step of (f) is conducted at a pressure of 0.1 to 10 MPa and provides a cooling rate of 20° C. per minute or more.

Preferably, the high shear environment of step (d) is a shearing speed of up to 5000 rpm.

Preferably, the step of continuously monitoring and adjusting the process based on alkali levels is assisted by the use of an AI-enhanced control unit within the automated de-alkalization testing subsystem to refine processing parameters based on real-time alkali levels.

Preferably, the step of forming the slurry includes the addition of ionized water to adjust pH levels and enhance the reactivity of chemical processes.

Preferably, the method further comprises a step of optimizing the energy efficiency and sustainability of the de-alkalization process by utilizing the energy recovery module within the slurry separation subsystem.

Preferably, the method further comprises a step of optimizing the transformation of de-alkalized biomass into high-density bioproducts utilizing the densification subsystem.

Preferably, the method further comprising a step of enhancing the calorific value and carbon content of densified de-alkalized bioproducts through thermal treatment using the thermal conversion subsystem.

Preferably, the method further comprising a step of producing biogas from the treated lignocellulosic material and water extracted during the de-alkalization process utilizing the biogas production subsystem.

Preferably, the method further comprising a step of generating carbon credits and renewable energy certificates (RECs) through sustainable operation and emission reduction achieved by the system, utilizing the carbon credits and renewable energy certificates (RECs) subsystem.

Preferably, the method is powered by renewable energy sources to minimize environmental impact and enhance sustainability through the renewable energy subsystem.

Preferably, the method further comprising steps for transporting, storing lignocellulosic material, de-alkalized lignocellulosic material, and bioproducts using the bioproduct storage and transport subsystem for sustainable logistic

In one embodiment, the present invention provides a de-alkalinized material derived from the method aforementioned.

In one embodiment, the present invention provides de-alkalized bioproducts derived from the system and/or method aforementioned. For instance, the bioproduct can be a solid biofuel substance comprising the de-alkalinized material, wherein the solid biofuel substance comprises the de-alkalinized material being carbonized at a temperature of 400 to 1000° C. in the absence of oxygen.

### BRIEF DESCRIPTION OF THE DRAWINGS

This invention will be described by way of non-limiting embodiments of the present invention, with reference to the accompanying drawings, in which:

FIG. 1 illustrates an overview of the system, apparatus and method for producing lignocellulosic feedstock in the present invention.

FIG. 2 illustrates an embodiment of the ultrasonic flow cells in the apparatus of the present invention.

FIG. 3 illustrates an embodiment of the ultrasonic enabled reactor vessel and high-shear agitator in the apparatus of the present invention.

FIG. 4 shows the connection between the high-shear agitator and an ultrasonic device from FIG. 3.

FIG. 5 shows the connection of the stabilizer and the agitator from FIG. 3.

FIG. 6 illustrates an embodiment of the stator skirt portion (bottom, left), the stator with base plate (right) and the impeller (top) of the apparatus in the present invention.

FIG. 7 shows a radial dispersion (in circled portion) formed during operation of the ultrasonic enabled reactor vessel in the present invention.

### DETAILED DESCRIPTION

One or more specific and alternative embodiments of the present invention will now be described with reference to the attached drawings. It shall be apparent to one skilled in the art, however, that this invention may be practiced without such specific details. Some of the details may not be described at length so as not to obscure the invention. For ease of reference, common reference numerals or series of numerals will be used throughout the figures when referring to the same or similar features common to the figures.

Unless otherwise defined, all technical and scientific terms used herein have the same meaning as commonly understood by one of ordinary skill in the art to which this invention belongs. The terminology used in the description of the invention herein is for describing embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed considering the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

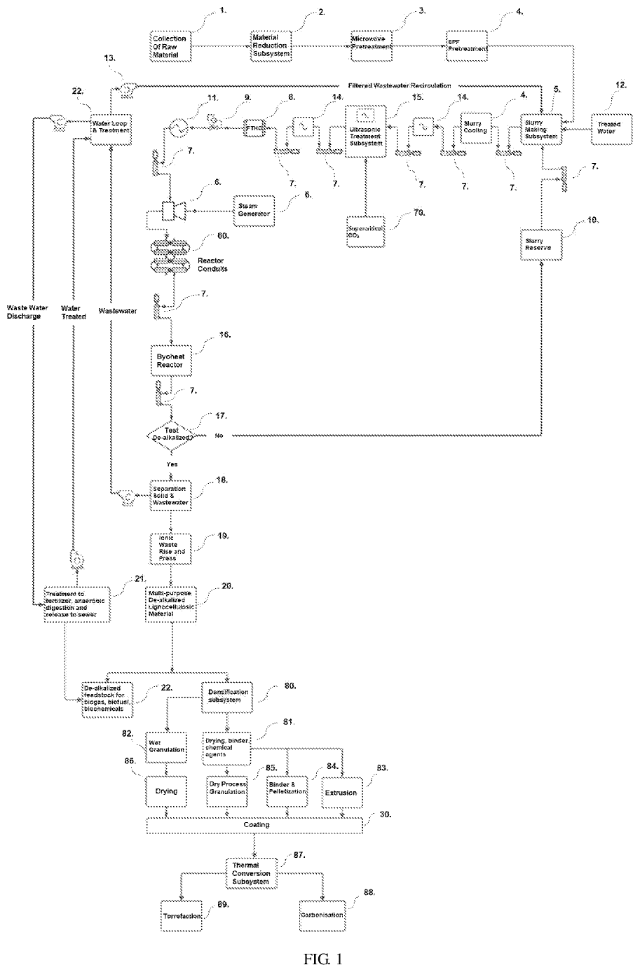

According to FIG. 1, the method for de-alkalizing lignocellulosic material and producing bio products, employing an integrated system comprised of specifically defined subsystems, modules and apparatus, designed for processing lignocellulosic feedstock into a de-alkalized state, the system includes:
(a) a collection subsystem (as denoted by 1) comprising a systematic collection module, configured to selectively gather lignocellulosic material from multiple sources, including agricultural residues, and forestry residues using a sensor-based identification system capable of distinguishing lignocellulosic material based on type, material conditions, and suitability for processing;
(b) a size reduction subsystem (as denoted by 2) to process the material into particle form where it can be seamlessly amalgamated with treated water and chemical agents, achieving a consistency conducive to fluid motion;
(c) a particle pre-treatment subsystem (as denoted by 3 and 4) using the combined electromagnetic energy processing module, and pulsed electric field (PEF), and ultrasound technologies significantly enhances the porosity and permeability of lignocellulosic material cells. This synergistic approach effectively disrupts cell walls and membranes, facilitating the breakdown of the lignocellulosic matrix into smaller molecules and improving the efficiency of subsequent de-alkalization processes;
(d) a slurry-making subsystem (as denoted by 5) for forming a flowable slurry from the pre-treated reduced size lignocellulosic particles by high shear shear mixing the particles with treated water and chemical agents;
(e) a direct steam injection sub-system (integrated into 5) to precisely contact and mix measured amounts of steam and lignocellulosic material slurry to induce hydrostatic cavitation, hydrolysis, cellular structural damage, loosing of the complex lignocellulosic structures, alkali neutralization, cell contents extraction osmosis and conversion of alkali to extractable aqueous forms;
(f) at least an ultrasonic flow cells subsystem (as denoted by 14) to leverage the mechanical and thermal effects of ultrasonic frequency wave hydrodynamic cavitation on the slurry in a pressurized and high-shear environment to further disrupt the cellular structure of the biomass, enhancing the removal of alkali and lignin components at cellular level. Intense cavitation generated by ultrasonic waves results in micro-jets and shear forces that facilitate the breakdown of complex lignocellulosic matrices, cell walls and improves the accessibility of cellulose and hemicellulose for enzymatic hydrolysis;
(g) at least a flow-through hydrodynamic cavitation (FTHC) sub-system (as denoted by 8) enhances cellulose and hemicellulose accessibility for enzymatic hydrolysis by disrupting cell wall structures, generating micro-turbulences and high-pressure zones to break down lignin-carbohydrate complexes, and aiding de-alkalization by removing alkali metals and substances;
(h) an ultrasonic treatment subsystem (as denoted by 15) for the disruption of cellular structures, loosening of lignocellulosic matrix, removing and neutralizing alkali at the cellular level of the lignocellulosic material in the slurry;
(i) a slurry separation sub-system (as denoted by 18) configured to separate the slurry into a liquid fraction (waste treated water) and a solid de-alkalized lignocellulosic material, in which ionic waste is removed from the solid separated particles and obtaining a de-alkalized lignocellulosic feedstock;
(j) a network of reactor conduits (as denoted by 60) configured to transport the heated slurry therethrough under a pressure of up to 200° C. and pressures up 10 bars for a predetermined amount of time;
(k) a heating vessel (as denoted by 16) configured receive slurry from the reactor conduits and further provide heating up to 200° C. and agitation thereof; and
(l) a water-recirculation and treatment sub-system (as denoted by 12 and 13) connecting the separation sub-system 18 and the slurry making sub-system 5 such that water discharged from the separation sub-system is recirculated to the slurry making sub-system or discharged to biogas production sub-system or after treatment to meet discharge requirements to the environment It shall be noted that water discharged from the activate a molecular vice to loosen the lignocellulosic material matrix during the ultrasonic processing and where the water cannot be circulated to produce bioproducts.

Further, in accordance to FIG. 1, the system comprises:
(m) an additional sub-system (as denoted by 22) by connecting the water-recirculating sub-system (12, 13) to a water-treatment plant, whereby the system takes up wastewater from the plant or discharge wastewater thereinto 5;
(n) an automated de-alkalization testing sub-system (as denoted by 17) employing advanced sensors network, automated precision-engineered volumetric sampling coupled with testing reactor throughout the de-alkalization system;
(o) a slurry pumping sub-system (as denoted by 7) transporting the lignocellulosie slurry throughout the system under pressure and high shear conditions; and
(p) a de-alkalized material densification sub-system (as denoted by 80) designed to efficiently compress and convert treated biomass into environmentally friendly, solid bio-based products for diverse applications (such as denoted by 30, 81 to 89).

Further, FIG. 1 shows that the system is adapted to enhancing the quality of densified de-alkalized bioproducts through thermal treatment to elevate their calorific value and carbon content, making them suitable substitutes for coal and coke in cement, steel, and supercritical power industries using a thermal conversion sub-system (as denoted by 87); a biogas production sub-system (as denoted by 22) that produces biogas from the recirculated water and water extracted during the pressing of the lignocellulosic material.

It shall be understood that the system can be adapted to a carbon credits and renewable energy certificates (RECs) sub-system (not shown) configured to register and generate carbon based tradable credits, tax related incentives and RECS generated by the application of system and method; a renewable energy sub-system (not shown) for generating energy to power the de-alkalization system; and a bioproduct storage and transport sub-system (not shown) utilising green transport, customized containers and digital AI-augmented logistics network to source lignocellulosic material and transport bio-products to customers.

Based on FIG. 1, it shall be understood that the system may be performed in a continuous manner, or in a batch manner by disconnection of any one of the sub-systems and/or apparatus as mentioned. The system, as described, is modular in design, allowing for flexible integration and scalable deployment across various industrial applications. Each module, operates both independently and synergistically, ensuring optimal performance in processing lignocellulosic materials into high-quality, densified bioproducts. This modular architecture not only facilitates the customization and expansion of the system to meet specific operational requirements but also enhances maintenance efficiency and system adaptability to evolving technologies and processes.

In particular, the collected lignocellulosic material is subjected to size reduction techniques to diminish the dimensions of the material to a scale where it can be seamlessly amalgamated with treated water and chemical agents, achieving a consistency conducive to fluid motion using the size reduction subsystem 2, the subsystem 2 comprises; one or more lignocellulosic material screening and washing modules using treated water and chemical agents to remove silica and foreign objects from the lignocellulosic material; one or more continuous pressurized and heated feed plugs screw feeder apparatus capable of injecting chemical agents into the lignocellulosic material upon exit from the screw to soften the material; the continuous feed plug screw feeder apparatus is further characterized by its ability to variably control the rate of chemical agent injection based on the exit material's characteristics and desired treatment outcome.

The subsystem 2 may further include a pressurized particle digestor apparatus for cooking and pre-heating the lignocellulosic material to a point sufficient to soften and weaken complex internal bonds of the lignocellulosic material; and essentially includes a particle-size reduction module 2 comprises a single or a combination of apparatus and method as set forth hereinafter, such as crushers, grinders, wet ambient and high-pressure milling, jet milling, ball milling, roller milling, ultrafine milling, pressurized refining apparatus, particle air classification mills, and/or colloid milling. The selection of these apparatus and methods are customized according to the specific properties of a lignocellulosic material. For example, the particle-size reduction unit 2 may comprise a crusher or shredding apparatus; followed by a dry or wet milling apparatus; and subsequently an air classifier, a wet milling apparatus or a colloid mill to obtain a uniform particle size. It is preferred that the particle-size reduction unit 2 provides solid particles sizes of less than about 10 mm, preferably less than about 5 mm, and more preferably about 2 mm, with a moisture content of about 40 wt % to about 60 wt % to overcome the challenges faced by most prior art. The biomass washing apparatus may include, but is not limited to rotary drum washers, screw washers, vibrating or shaking screens, paddle washers, hydro cyclones, spray washers and dipping and soaking tanks.

Accordingly, the lignocellulosic material is pre-treated to the increase the porosity of the materials cell using the particle pre-treatment sub-system (3 and 4) comprising: a continuous electromagnetic energy processing module 3 to apply electromagnetic energy to the particles and pulse electric field (PEF) module 4. As seen in FIG. 1, the particles are firstly conveyed to a continuous-flow microwave oven 3 designed to handle the powder with a power range of 1-5000 MHz. Exposure to high-power continuous-feed electromagnetic energy can result in the molecular breakdown of the lignocellulosic material into smaller molecules due to the energy transfer from the electromagnetic energy processing modules. This process is known as depolymerization or fragmentation. The system can be made continuous by providing conveyor between each component.

The lignocellulosic material pre-treatment sub-system further pre-treats the particle by exposing them to electromagnetic energy processing module and pulse electric field (PEF) thereby further breaking down the particles in the molecular/cellular level. Alternatively, the particles may be subjected to a electromagnetic energy processing module-assisted extraction (MAE) system (not shown) whereby it combines electromagnetic energy processing module and ultrasonic technology to facilitate the disruption in the molecular/cellular level, followed by the PEF module. The ultrasound technology utilizes the cavitation phenomenon to physically damage cell walls and membrane layers, resulting in the release of target compounds and promoting increased mass transfer and accelerated solvent penetration. The electromagnetic energy processing module radiation rapidly heats the biomaterial, inducing the migration of dissolved molecules. Consequently, the simultaneous or successive application of ultrasound and electromagnetic energy processing module treatments achieves a higher alkali extraction period.

The disclosed electromagnetic energy processing module involves a non-contact energy transfer from electromagnetic energy into thermal energy through ionic conduction and dipole rotation. Non-ionizing radiation induces molecular motion via migration of ions and rotation dipoles. Exposure to high power from the electromagnetic energy processing module can result in the breakdown of molecules in the lignocellulosic material due to the energy transfer from the electromagnetic energy processing modules. This process is known as depolymerization or fragmentation. The use of electromagnetic energy processing module technology offers several advantages, such as faster energy absorption by the treated material at the cellular level, reduced thermal gradients, higher efficiency in shorter extraction time, and selective heating. Additionally, electromagnetic energy processing module heating of the moisture inside each cell of the treated biomaterial creates high pressure on the cell wall, leading to mechanical rupture. Recent studies demonstrate that solvent penetration, including water in liquid or steam form, is enhanced and penetrates deep into the tissues.

The disclosed PEF is based on the process of “electroporation”, also known as “electro-permeabilization”. By applying a high voltage electric field, it is expected that all cell membranes are disrupted, loss of barrier function, leakage of intercellular content, loss cell vitality and causes pores to form. This greatly enhances the permeability of the membranes and improves the diffusion efficiency of targeted compounds.

According to FIG. 1, the particle-size reduction unit 2 is connected by conveyor to a electromagnetic energy processing module 3 and then a pulsed electric field process (PEF) apparatus 4. The particle-size reduction module 2 is preferably connected to the electromagnetic energy processing module 3 by means of a conveyor, such that the particles can be transported continuously or automatically into the electromagnetic energy processing module 3. The electromagnetic energy processing module 3 comprises a electromagnetic energy processing module oven capable of treating the particles in a power range of about 500 MHz to about 5000 MHz. Subsequently, the electromagnetic energy processing module-exposed particles are then fed by a conveyor into a pulse electric field processor (PEF) apparatus 4 with the objective to apply a high voltage pulse to disintegration the cell wall and membrane of each cell in the particles passing through the PEF. In one embodiment, it is preferred that the PEF operates with a micro-second high voltage pulses in the order of about 10-100 kV.

The invention further comprises a method to form a flowable slurry from the pre-treated reduced size lignocellulosic particles by high shear mixing the particles with treated water and chemical agents in a slurry-making sub-system 5, the subsystem comprises:
a. a treated water preparation module: fresh water and recirculated de-alkalization system treated water is treated through a series of purification and conditioning steps to optimize the treated water's characteristics to facilitate effective slurry formation. The treated water may be supplemented with additional chemical agents that aid in the slurry-making process and downstream processing.
b. a pressurized, high shear mixing module: using one or more cylindrical flow through vessels, high shear mixing and cavitation pumps configured to receive and mix lignocellulosic particles transported from the particle pre-treatment sub-system 3, 4 with treated water through the application of high shear cavitation mixers and pump apparatus;
c. a control unit configured to control the amount of de-alkalizing agent and liquid based on a target de-alkalization level;
d. a pump connected to the mixing chamber for circulating the slurry through the de-alkalization system;
e. a sensor array and digital control system positioned to monitor characteristics of the slurry, wherein the control unit adjusts the slurry composition based on feedback from the sensor array;
f. a slurry chilling module to reduce the temperature of the slurry to less than 25 degrees celcius.
g. a pressurized cylindrical flow-through vessel that transports the slurry through one or more ultrasonic flow cell sub-systems to the direct steam injection subsystem.

h. To regulate the quantity and/or speed at which the powder is added to the liquid, a metering valve is preferably employed.

For the purpose of understanding, definitions of the terms used are provided. “Treated water” refers to any water that has undergone processing or treatment to modify its chemical composition, physical properties, or biological content to meet specific requirements of the de-alkalization process described herein. This includes, but is not limited to:
Ionized Water: Water that has been treated to alter its ion concentration, specifically to adjust its pH level or to enhance its reactivity in chemical processes.
Distilled Water: Water that has been purified through distillation, removing impurities and contaminants to achieve high purity levels, suitable for sensitive de-alkalization reactions.
Recirculated Treated Water: Water that has been used in previous processes, treated to remove impurities or adjust its composition, and recirculated back into the system to minimize waste and optimize resource efficiency.
Water mixture, or Water With Chemical Agents Added: Water to which specific chemical agents have been added to enhance its effectiveness in the de-alkalization process. These agents may include but are not limited to, acids, bases, salts, or other compounds designed to facilitate or catalyze specific reactions within the biomass material.

The invention includes a method for passing lignocellulosic particle slurry through one or more ultrasonic flow cells equipped with cell-breaking capabilities employing the ultrasonic treatment sub-system 15 to leverage the mechanical and thermal effects of ultrasonic waves to further disrupt the cellular structure of the biomass, enhancing the removal of alkali and lignin components. The intense cavitation generated by ultrasonic waves results in micro-jets and shear forces that facilitate the breakdown of complex lignocellulosic matrices, cell walls and improves the accessibility of cellulose and hemicellulose for enzymatic hydrolysis.

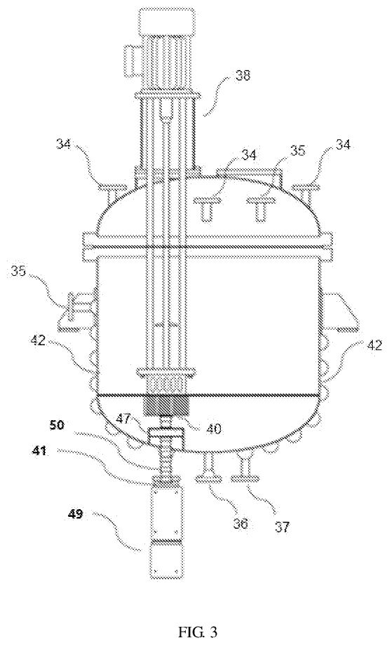

The ultrasonic treatment sub-system 15 comprises at least an ultrasonic enabled reactor vessel module as shown in FIG. 3. The module comprises an ultrasonic enabled reactor vessel comprising an inlet and an outlet connected to the ultrasonic flow cells 14 to receive slurry via progressive pumps 7. The ultrasonic enabled reactor vessel is double-jacketed (not shown) and is capable of rapid heating and cooling of the slurry therein. According to FIG. 3, The reactor comprises a heating and cooling jacket outlet 37 which allows for the circulation of heating or cooling medium, such as water, oil and/or molten salts to deliver the most efficient and rapid temperature augmentation therein. The reactor may further include pressure relief valve, sound proofing layer and inlet to receive water and/or chemicals.

The ultrasonic enabled reactor vessel is configured with means to hold one or more ultrasonic devices. As shown in FIG. 3, the reactor comprises a plurality of ports 35 to hold the ultrasonic devices at the top 34, bottom 41, side walls 42 in order to generate a uniform and high ultrasonic resonance within the reactor. More specifically, the port configured at the bottom 41 of the reactor wall also allows connection of the probe 50 and transducer 49 of the flow cell 14 in vicinity to a rotor-stator assembly 26 where slurry is applied with high shear forces.

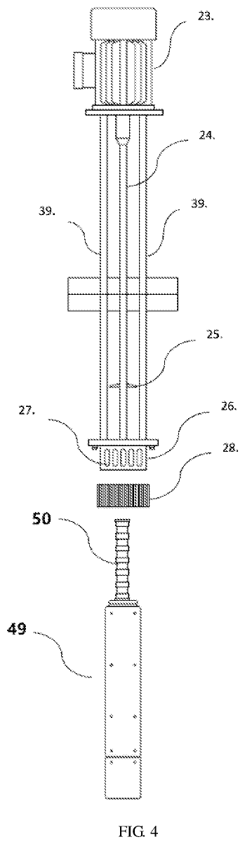

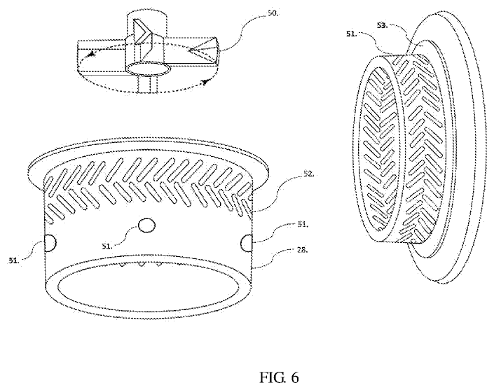

According to FIG. 3, the ultrasonic enabled reactor vessel comprises a high-shear agitator 38 preferably located slightly off-centre in the reactor to prevent creating vortexes in the centre of the reactor during operation. In an embodiment of the invention according to FIGS. 3 and 4, the high-shear agitator 38 comprises a motor 23, a rotor shaft 24 and a rotor-stator assembly 26, wherein the rotor shaft includes at least a down draft impeller 25 with at least a rotor blade having a surface that is obliquely angled relative to the axis of rotation. According FIG. 6, the blade has a wedged-surface 50 which demonstrates an increased shear force during operation.

According to FIG. 4, the rotor-stator assembly 26 located at the base of the agitator 38 to connect with the ultrasonic device 49, 50 attached at the bottom of the reactor thereby transmitting ultrasonic emission from the ultrasonic device to the reactor. The assembly 26 comprises a rotating rotor and stator sidewall having a plurality of slot openings 27 to accommodate the ultrasonic device 49, 50. Further, according to FIGS. 4 and 6, the assembly 26 is configured with an extended skirt portion 28 having a vented portion 52 and a plurality of orifices 51 to connect a stabilizing means. The vented portion 52 may have a wedged-pattern.

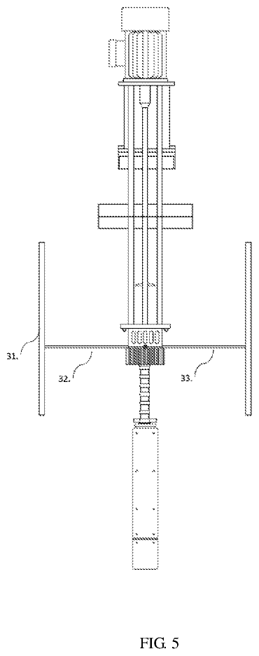

Accordingly, the high-shear agitator 38 further comprises a stabilizing means with one side lying against the reactor wall and another side fastened to the stator 26 through the skirt portion 28 thereby stabilizing the agitator within the reactor. According to FIGS. 4 and 5, the stabilizing means comprise of a pair of longitudinal rods 31 and a horizontal rod 32. More particularly, the horizontal rod 32 is fasten to the stator, and the longitudinal rods 31 are extended perpendicularly at both ends of the horizontal rod 32. The horizontal rod 32 extends through the orifices 51 and reaches to two opposite walls of the reactor, while the longitudinal rods 31 extends long the height of the reactor thereby countering the forces induced by a combination of the operation of the agitator and the ultrasonic field in close proximity.

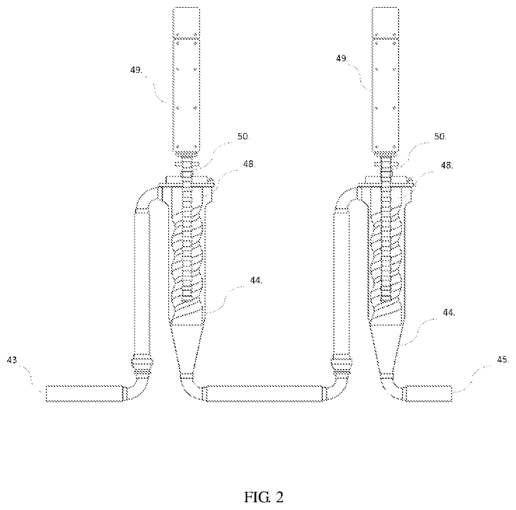

Preferably, the stabilizing means is configured as a channel in connection with the supercritical fluid source 70. In one embodiment, the horizontal rod 32 can be configured to use as a channel to receive supercritical fluid through the vented portion 52 of the skirt 28. Alternatively, the agitator 38 may comprise a perforated annulus 47 located in vicinity to the skirt 28 of the rotor-stator assembly to receive the supercritical fluid source 70. According to FIGS. 2 and 3, a supercritical carbon dioxide (CO₂) can be pumped into the reactor from the flow cell attached at the bottom thereof, and being distributed in vicinity to the rotor-stator assembly 26.

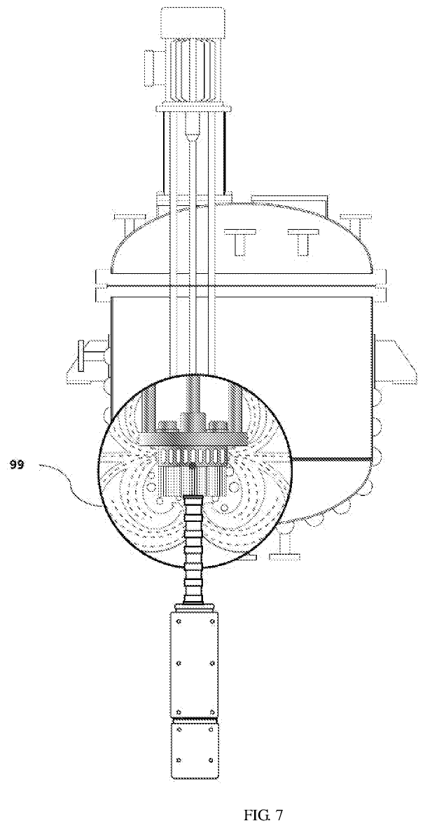

In view of the aforementioned arrangement, the arrangement of the impeller 25 and the ultrasonic probe devices 49, 50 mounted at the bottom wall of the reactor is able to concentrate ultrasonic power around the rotor-stator 26, creating a high shear agitator flow with a radial dispersion 99 as illustrated in FIG. 7. In this arrangement, the slurry in the reactor should pass through the rotor-stator 26 multiple times per minute, enabling efficient slurry mixing and processing.

The supercritical CO₂ introduced into the reactor is used as an extraction co-solvent with water. In general, the temperature range for the extraction of alkali using supercritical CO₂ ranges from 40° C. to 80° C., with a pressure of 10 MPa to 40 MPa. The addition of water to supercritical CO₂ creates a binary solvent system that can enhance the extraction efficiency of the system. In this binary solvent system, the supercritical CO₂ acts as the primary solvent, while water acts as a co-solvent that enhances the solubility of hydrophilic compounds, such as potassium-containing compounds. The water molecules can penetrate the cell walls of the plant material and dissolve the hydrophilic compounds, which are then carried away by the supercritical CO₂ solvent. The use of supercritical CO₂ and water as a binary solvent system offers several advantages over traditional extraction methods. It is a non-toxic, non-flammable, and environmentally friendly system and process that can extract a wide range of compounds from natural products, including potassium-containing compounds. Additionally, the use of supercritical CO₂ allows for precise control over the temperature and pressure conditions, resulting in a more efficient and selective extraction system.

In an embodiment, other agitators in the system or apparatus, such as those in the direct steam injection sub-system 5, may incorporate a similar agitator 38 to the reactor, particularly having the rotor-stator assembly 26. Appropriate modifications may be made during incorporation, as the case may be.

Subsequently, the slurry is pumped through another flow cell 14 under positive pressure from reactor outlet using high shear pumps to the inlet of another heating vessel 16 to complete a pressurized liquid extraction (PLE) of the intercellular material and ionized alkali ions. If necessary, chemical agents are added in the slurry. The heating vessel 16 comprises an inlet and outlet, a rapid heating jacket, an additional inlet to receive water and/or chemicals, a sound proofing insulation, a high-shear agitator similar to the agitator 38 in the reactor, and an automated high-pressure relief valve. The heating vessel 9 is specifically designed to swiftly and efficiently heat the slurry, all while subjecting it to high shear agitation, with temperatures ranging from 50° C. to 250° C. Advantageously, the extraction in vessel 9 reduces solvent consumption and shortens duration of extraction. Thereinafter, the slurry discharged from the vessel 16 is subjected to alkali testing in alkali testing subsystem 17.

The ultrasonic flow cell subsystem 14 is composed of; ultrasonic probe apparatus, typically made of piezoelectric material that generates ultrasonic waves when an electrical signal is applied, is the component that emits ultrasonic waves into the liquid flowing through the cell. According to FIG. 3, the ultrasonic flow cell subsystem 14 comprises: (i) a pressurized cylindrical flow-through vessel 44 with a cooling jacket, a high shear geometry inlet 43 and outlet 45 made of a material compatible with the liquid being measured and the ultrasonic waves, such as stainless steel, glass, or plastic, in which the vessel 44 contains the ultrasonic probe 50 and the slurry flowing through the ultrasonic flow cell; (ii) a helical-shaped baffles 48 within the said vessel 44 to guide the fluid flow along a helical path to ensure even exposure for each particle in the slurry to ultrasonic treatment; (iii) an ultrasonic signal generator and receiver, in which the flow cell is connected to an ultrasonic signal generator and receiver, which provides the electrical signal to the ultrasonic probe and detects the reflected signal from the liquid, allowing for the calculation of the velocity of the liquid and determination of flow rate and other properties; (iv) pressure censors apparatus to monitor the pressure within the ultrasonic flow cell; (v) temperature sensor to measure the temperature of the liquid flowing through the cell, which can be used to correct for temperature-related changes in the speed of sound in the liquid; and (vi) digital control centre augment by AI machine learning to adjust flow rate, pressure, temperature and ultrasonic treatment. Advantageously, the inlet 43 and outlet 45 are designed to allow the slurry to flow through the cell whilst minimizing turbulence and ensuring a consistent, high-shear flow rate through the cell.

According to FIG. 1, there are a plurality of ultrasonic flow cells 14 placed upstream and downstream to the ultrasonic treatment subsystem 15. According to FIG. 2, the ultrasonic flow cells 14 provide ultrasonic treatment of the slurry in a flow cell housing 44 configured with a relatively confined and guided flow path. A connection of flow cells upstream and downstream to the ultrasonic treatment subsystem 15 enhances the overall ultrasonic treatment effect. Preferably, each housing 44 works under a pressure of 0.1 MPa to 10 MPa. Each housing 44 comprises an ultrasonic probe 50 driven by a transducer 49 that operates at a frequency range of 10 Hz to_MHz with a power range of 100 W to 20,000W.

In an embodiment, the housing 44 includes a helical baffle 48 configured to provide a helical flow path to the slurry during passage. The benefits of the helical flow path improve agitation across the entire cross-section of the flow cell with minor turbulence and pressure drop. The flow cells further include sensors and regulators (not shown) for monitoring and adjustment of pressure and temperature therein. The flow cells further include ultrasonic signal receiver (not shown) which connects to the probe 50 and provide derivation of fluid velocity and flow rate therefrom.

In a further embodiment, the design incorporates a helical baffle design that spans the entire length of the internal walls cylindrical flow-through vessel, serving either as an inserted component or as an integral helical casting within the walls of the aforementioned vessel. This configuration is specifically engineered to enhance fluid dynamics and thermal distribution within the vessel, promoting efficient processing and uniform treatment of materials passing through. The helical design not only optimizes the flow pattern to maximize contact between the fluid and the vessel's internal surfaces but also contributes to improved heat transfer and mixing efficiency.

The invention, further processes the slurry through mechanical cavitation, utilizing a flow-through hydrodynamic cavitation (FTHC) subsystem 8, further disrupts the complex structures of the cell walls, enhancing the accessibility of cellulose and hemicellulose for enzymatic hydrolysis. The FTHC subsystem generates micro-turbulences and localized high-pressure zones, which are key for breaking down lignin-carbohydrate complexes, thereby facilitating efficient biomass conversion. Moreover, this process plays a crucial role in de-alkalization, aiding in the removal of alkali metals and other alkaline substances. The flow-through hydrodynamic cavitation (FTHC) subsystem 8, comprises: an inlet configured to receive the slurry; a flow path integrated with at least three distinct zones designed for inducing vigorous vortex formation and intense cavitation within the flowing slurry; an outlet for the cavitated fluid; a pressure reduction apparatus operatively connected to said outlet for facilitating pressure decrease in the fluid; an automated high-pressure stepdown and relief valve apparatus, wherein said apparatus is configured to dynamically adjust fluid pressure through the subsystem to maintain optimal cavitation conditions within the at least three distinct zones; and a real-time slurry characterization and adaptive control module comprising: inline sensors for the continuous assessment of physical and chemical properties of the slurry, an digital artificial intelligence-based analysis unit to process data from the sensors and determine optimal operational parameters for the subsystem based on real-time slurry characteristics.

The system further comprises a direct steam injection sub-system 5 connected downstream to the FTHC subsystem 8, that precisely contacts and mixes measured amounts of high pressure and temperature steam and lignocellulosic material slurry to induce hydrostatic cavitation, hydrolysis, cellular structural damage, loosing of the complex lignocellulosic structures, alkali neutralization, cell contents extraction osmosis and conversion of alkali to aqueous salts. Meanwhile, the sub-system 5 induces hydrostatic cavitation in the slurry. The hydrostatic cavitation involves the rapid expansion and contraction of steam bubbles, which can create shock waves that potentially cause mechanical and chemical disruption to the lignocellulosic material without liquefaction of the underlying material.

In one embodiment, the direct steam injection sub-system 5 comprises:
a) a boiler module for generating steam, preferably powered by energy from renewable energy sources, including but not limited to biogas, solar power, biomass-to-energy power plants and hydrogen;
b) a main steam distribution cylindrical flow-through vessel connected to said boiler for transporting steam;
c) a direct steam injection module comprised of:
   i) direct steam injection flow through vessel apparatus comprised of:
   ii) a having an inlet for receiving biomass feed and an outlet for discharging processed biomass material;
   iii) a novel helical baffle system apparatus incorporated within the said vessel, configured to direct the biomass in a spiral path from the inlet to the outlet, thereby maximizing exposure of the biomass to steam for enhanced heat transfer and facilitation of chemical reactions essential for de-alkalization;
   iv) multiple injection nozzles connected to the main steam distribution pipe within the vessel, arranged to ensure uniform steam distribution across the biomass material;
   v) a secondary steam injection nozzle positioned next to the outlet of the pressurized cylindrical flow through vessel, ideally incorporating the helical baffle, positioned before the to precisely mix steam with heated slurry;
d) a condensate recovery system for capturing and recycling treated water from the steam, thereby improving the efficiency of the system;
e) a cylindrical-shaped flow through a reaction conduit connected to the outlet of the direct steam injection apparatus that transports the heated slurry in pressurized and high-temperature conditions through the length of the reaction conduit that is optimized to ensure residence time is sufficient for alkali neutralizing agents have the highest impact. The reaction conduit pressure and temperature are controlled by a digital machine learning enhanced process control unit that can be dynamically adjusted to affect the de-alkalization and related chemical reactions;
f) a pressurized agitation vessel module, composed of:
   i. rapid heating jacket apparatus
   ii. one or more inlets to receive lignocellulosic slurry, treated water or chemical agents;
   iii. one or more outlets connected to slurry cooling apparatus to reduce the temperature of the slurry before it is transported to the slurry separation unit;
   iv. a high shear agitator that is top or bottom mounted in the tank.

In the present invention, the de-alkalizing apparatus operates in a pressurized loop. It is preferred that the loop maintains a pressure between about 0.1 MPa to about 10 MPa throughout the operation, unless otherwise stated. The application of such pressure increases the intensity of each component applied in the system, and also increases permeability of the plant cell walls in the lignocellulosic material, making it easier to extract cytoplasmic contents therefrom. This is particularly advantageous for tougher or more fibrous plant materials like oil palm empty fruit bunch, where traditional extraction and de-alkalization methods may not be as effective. Further, the pressurized loop optimizes process intensification, such as increasing effectiveness of ultrasound treatment, flow-through cavitation, superheated steam treatment, penetration of extraction agents and solvents, such as water, into every single plant cell. This results in a more efficient extraction system, cell-level de-alkalization and increased yields of valuable components. Hence, the de-alkalizing apparatus which operates in a pressurised loop is able to overcome the limitations and lack of scalability of each technology incorporated into the system as compared to using them in isolation to process a lignocellulosic material.

In the present invention, components of the de-alkalizing apparatus are provided with pressure regulating devices, such as, pressure relief valves 9, differential pressure reducing regulators, or being connected via progressive cavity pumps 7. Preferably, progressive cavity pumps with a conveying capacity of about 3 m³/h to 500 m³/h and pressure of less than about 4.8 MPa. The apparatus preferably employs vessels or reactors capable of withstanding the pressure used.

In one embodiment, the present invention provides an apparatus for de-alkalinizing lignocellulosic material, comprising: (a) a cooling vessel 4 configured to reduce temperature of the slurry to a temperature of 2 to 20° C.; (b) a first set of ultrasonic flow cells 14, preferably incorporating a helical flow cell vessel insert configured to transfer the slurry from the cooling vessel to an ultrasonic enabled reactor vessel along a helical pathway, wherein the ultrasonic flow cell subjects the slurry to a pressure of 0.1 to 20 MPa at an ultrasonic frequency range of 10 MHz to 50 MHz; (c) one or more ultrasonic enabled reactor vessel 15 comprising at least one ultrasonic device and a high-shear agitator having a rotor-stator assembly, wherein at least one of the ultrasonic devices is located in vicinity to the rotor-stator assembly to concentrate ultrasonic field frequency of 10 MHz to 50 MHz around the rotor-stator assembly; (d) a second set of ultrasonic flow cells 14, preferably incorporating a helical flow cell vessel insert configured to transfer the slurry from the cooling vessel to an ultrasonic enabled reactor vessel along a helical pathway, wherein the ultrasonic flow cell subjects the slurry to a pressure of 0.1 to 20 MPa at an ultrasonic frequency range of 10 MHz to 50 MHz; (c) a flow-through hydrodynamic cavitation (FTHC) unit 8 configured to transfer the steam injected slurry while subjecting it to pressurization at about 0.1 to about 100 MPa thereby inducing hydrodynamic cavitation therein; (f) a direct steam injection device 5 configured to inject steam into a lignocellulosic slurry at a temperature of up to 250° C. and pressure of up to 21 MPa; (g) a network of reactor conduits 12 configured to transport the heated slurry therethrough under a pressure of up to 200° C. and pressures up 10 bars for a predetermined amount of time; and (h) a heating vessel 16 configured receive slurry from the reactor conduits and further provide heating up to 200° C. and agitation thereof.

Preferably, the ultrasonic enabled reactor vessel further connects to a supercritical fluid source 70. It is preferred that (a) to (h) are connected in a loop though progressive cavity pumps and pressure relief valves are provided throughout the loop.

The cooling vessel 4 capable of reducing temperature of heated slurry a temperature suitable for ultrasonic treatment of the slurry thereinafter, more preferably to a temperature range 50° C., more preferably 2 to 20° C. The cooling vessel 4 comprises a vessel with an inlet and outlet, a rapid cooling jacket surrounding the vessel, a heat exchanger, a high shear agitator to agitate the slurry in the vessel, a high-pressure relief valve and may further comprise of additional inlet to receive water or chemicals into the vessel. Once the temperature of the slurry in the cooling vessel 4 drops below 50° C., it is pumped through progressive cavity pumps 7 through one or more ultrasonic flow cells.

The alkali levels of the material are tested at each de-alkalization sub-system and for each complete pressurised loop using an alkali-testing sub-system 17. The sub-system 17 comprises a slurry volumetric testing module that employs advanced sensors and automated precision-engineered volumetric sampling tap apparatus designed throughout the de-alkalization system and an digital analytical module to continuously measure and communicate the concentration of alkali in the slurry in real-time in each subsystem and slurry reserve tank and reprocessing module; If the test confirms that the lignocellulosic material in the slurry has been sufficiently de-alkalized, the material is separated into wastewater and solid low-alkali material. If the solid material is not sufficiently de-alkalized after testing, it is recirculated to the slurry reserve vessel through a pressurised loop for reprocessing until the desired level of de-alkalization is achieved. The recirculated slurry is then pumped from the slurry reserve vessel to the first heating vessel and re-enters the pressurised loop.

The alkali-testing sub-system further comprises a slurry testing reactor apparatus coupled to the automated sampling apparatus, wherein the testing reactor is configured to assess the alkali level of the slurry samples using. In an embodiment of the reactor a spectrophotometric analysis unit capable of determining alkali concentration via absorbance measurements at specific wavelengths, utilizing reagents that react with the alkali components to produce colorimetric changes directly proportional to the alkali concentration, thereby allowing for rapid and precise quantification. In another embodiment, the alkali testing is performed in a reactor vessel having a reagent delivery system, and a digital monitoring system. During alkali-testing, the slurry is first mixed with an appropriate alkali solution and then fed into the reactor vessel at a controlled flow rate. The alkali solution reacts with lignocellulosic material in the slurry to break down its complex structure and release the desired compounds. The reaction is monitored online using a pH or conductivity sensor to measure the alkali concentration in the reactor vessel. The reagent delivery system can be adjusted to maintain a constant or changing alkali concentration in the reactor vessel. A continuous flow reactor system provides a highly controlled environment for testing alkali levels in lignocellulosic material, enabling precise measurement and control of the reaction conditions.

After passing the de-alkalization test, the slurry enters the slurry separation sub-system 18 and it is separated into a liquid fraction (wastewater) and a solid de-alkalized material using solid separation apparatus such as centrifuges, screw presses, belt presses, presses, screens, filters, and hydro-cyclones. A high-pressure treated water spray module is integrated with the separator for the removal of ionic waste and neutralise chemical agents in the treated water through targeted application whilst it undergoes mechanical and high-pressure separation. In the slurry separation sub-system 18, the separated solid de-alkalized material is mechanically pressed to remove excess water and ionic waste material. A high-pressure freshwater spray device can be used within the separator or on it in the case of a vertical screen separator to remove ionic waste efficiently. The washing and pressing steps are continuous, ensuring a consistent supply of de-alkalized material particles. The slurry separation subsystem if further comprised of a filtration module equipped with particle filters designed to remove particles larger than 1 micron from the separated waste-treated water; and a waste treated water storage module consisting of vessels for holding the filtered waste-treated water, equipped for recirculation within the system; a digital slurry separation sub-system management unit, programmed to optimize the operation of the separation, spray system and filtration processes based on real-time data analysis of water quality and separation efficiency metrics.

Further, in an embodiment of the invention includes a novel sensor array module, integrated into the separation subsystem, for comprehensive monitoring of solid waste composition, water quality, and ionic waste concentration, providing data inputs to the AI-based management unit.

According to FIG. 1, the system comprises a separated water-recirculation and treatment sub-system comprises: a water loop and treatment module 12 employing a combination of water treatment apparatus, including but not limited to, vapor distillation, reverse osmosis, ion exchange, chemical precipitation, or anaerobic I1 and operation of the treatment processes are dynamically managed by the AI platform based on real-time water quality parameters, operational efficiency, and compliance requirements; connection to a treated water biogas sub-system configured to receive recirculated treated water that will not be processed by the water treatment module; At least one treated water storage vessel module; a treated water and chemical saturation testing module to monitor treatment and discharge levels orchestrated by the AI management module. The sub-system further includes; a treated water treated water discharge module where the treated water will be discharged without further treatment to; an anaerobic digestion pond apparatus or biogas digestor apparatus to produce biogas and related bioproducts; a biochemical manufacturing apparatus; an evaporation, electrochemical or ion exchange apparatus to produce potassium from the potassium-concentrated discharged treated water; wherein the conversion process is optimized by the digital AI enhanced management platform distributed throughout the water recirculation and treatment subsystem for maximum recovery of nutrients and minimal environmental impact. Further, one or more wastewater vessels that receive the filtered wastewater, eliminating any solid particles. These vessels are linked to a sub-system for water treatment and recirculation, which conserves water and minimizes the environmental footprint of the system.

As the concentration of hydrolyzed potassium, including potassium hydroxide (KOH), and other alkali increases in the water, the system generates its own chemicals and solvents, ensuring cost-effectiveness and sustainability. Recent studies provides that the hydrolyzed alkali solvents present in recirculating wastewater, such as KOH and HCL, can effectively expand the biomass structure matrix or break down the complex structures of lignin and cellulose after their concentration reaches 1% or more of the volume of water. As these chemicals are recirculated with each cycle, their concentration increases, resulting in the formation of a molecular vice when the slurry passes through the cellular ultrasonic treatment subsystem. The molecular vice once activated during ultrasonic treatment of the slurry primarily involves delignification of the lignocellulosic material through various chemical mechanisms, such as breaking ether linkages between aromatic moieties and climinating side chains (Liu et al., 2019). The addition of KOH or sodium hydroxide to the slurry can initiate the creation of the molecular vice through hydrolyzed ionic alkali. The addition of KOH or sodium hydroxide to the slurry can initiate or accelerate the effectiveness of the molecular vice created by hydrolyzed ionic alkali extracted and recirculated through the pressurised loop.

Additionally, the introduction of a reduced lignocellulosic material particle size increasing surface area and molecular vice's loosening and breaking down of the complex structure of lignocellulosic material and improve enzyme accessibility improving its digestibility, increasing the efficiency of lignocellulosic material conversion processes including but not limited to anaerobic digestion, biofuels and biochemicals.

Once the re-circulating water reaches its saturation point, it is discharged into various downstream lignocellulosic feedstock processing unit, whereby the de-alkalized lignocellulosic feedstock is used in the feedstock processing unit to produce into biogas, biofuel and/or biochemicals. For instance, a downstream processing unit to produce high potassium fertilizer, a downstream processing unit for anaerobic water treatment, or a downstream processing unit for utilizing the feedstock for bio-gas, bio-chemicals, and biofuel processes post-treatment.

Transporting the lignocellulosic slurry throughout the de-alkalization system under pressure and high shear conditions using a slurry pumping sub-system for transporting and processing the slurry, comprising:
(i) a progressive cavity pump module, including multiple pumps arranged in series or parallel, configured to transport the slurry with a conveying capacity between 3 and 500 m³/h and to generate a positive pressure up to 48 bar within the system and subsystems, thereby establishing a self-sustaining positive pressure loop without the need for external pressure sources;
(ii) a high shear cavitation pump module, including multiple pumps arranged in series or parallel equipped with adjustable shear blades and a proprietary blade design that creates micro-cavitation zones within the slurry, arranged to receive the slurry from the progressive cavity pump subsystem and apply variable shear forces to the slurry during transportation based on specific de-alkalization requirements, thereby enhancing the adaptability and efficiency of the de-alkalization process;
(iii) an automated AI enhanced feedback control module that monitors the pressure and shear levels within the system, adjusting the operation of the progressive cavity and high shear cavitation pumps in real-time to maintain optimal de-alkalization conditions and energy efficiency;
(iv) a novel gas injection module positioned between the progressive cavity pump subsystem and the high shear cavitation pump subsystem, designed to introduce a controlled amount of gas selected from a group including, but not limited to carbon dioxide (CO₂), oxygen (O₂), nitrogen (N₂), air, and hydrogen (H₂), into the slurry to facilitate specific chemical reactions or to create an inert atmosphere within the de-alkalization process, further enhancing the efficiency and effectiveness of slurry de-alkalization treatment under positive pressure based on the slurry's characteristics and the de-alkalization requirements of each sub-system; and
(v) an energy recovery module capable of harnessing the kinetic energy generated by the slurry movement within the system, converting it into electrical energy, and utilizing it to power the system's pumps, contributing to the system's energy efficiency and sustainability.

The integrated system produces a multi-purpose de-alkalized solid feedstock which can be used in various additional system steps to create different product. In one embodiment, the de-alkalized lignocellulosic feedstock is used for production of solid fuel pellet, wherein the pellet comprises the de-alkalinized material being carbonized at a temperature of 400 to 1000° C. in the absence of oxygen.

The invention, further processes the de-alkalized biomass into high-density bioproducts using a de-alkalized material densification subsystem, designed to efficiently compress and convert treated biomass into environmentally friendly, solid bio-based products for diverse applications comprising:
a. a drying module for removing moisture from lignocellulosic materials, including by not limited to, rotary dryers, conveyor dryers, flash dryers, fluidized bed dryers, spray dryers, drum dryers, microwave dryers and vacuum dryers. The de-alkalized feedstock is be dried 16 to less than 15% wt % moisture content and compressed into pellets, briquettes, or extruded and coated with a hardening agent prior to thermal treatment;
b. a mixing unit for adding a binder and chemical agents to the dried lignocellulosic materials, wherein the binder is selected from the group consisting of starch, lignin, polyvinyl acetate, urea-formaldehyde, phenol-formaldehyde, and epoxy resins, and the chemical agents include but are not limited to fire retardants, water repellents, insect repellents, and fungal growth inhibitors, further including micro-fibrillated cellulose products for enhanced mechanical properties;
c. a densification device for compressing the mixture into a densified material, capable of creating a gradient density in the densified material, including but not limited to a hydraulic press, screw press, pellet mill, including single-screw and twin-screw extruders, for uniform cross-sectional product creation, granulators, roller presses, and high-pressure homogenizers;
d. an AI-enhanced control system designed to optimize the process parameters based on input material characteristics and desired output specifications, utilizing machine learning algorithms to predict optimal process parameters and dynamically adjust the mixture of binders and chemical agents based on real-time feedback; and
e. a nano-scale surface modification unit for modifying the surface of the lignocellulosic materials at the nano-scale using chemical agents to enhance binding with the binder and improve the mechanical strength of the densified material,
wherein the entire system incorporates a modular design allowing each component to be interchangeable and customizable based on specific requirements.

The invention, enhancing the quality of densified de-alkalized bioproducts through thermal treatment to elevate their calorific value and carbon content, making them suitable substitutes for coal and coke in cement, steel, and supercritical power industries using a thermal conversion sub-system, the system comprises:
a. A torrefaction module is designed to heat treat the de-alkalized feedstock in an oxygen-depleted, nitrogen-enriched environment at temperatures ranging from 200° C. to 400° C., with a residence time between 60 minutes and 120 minutes. The nitrogen-enriched environment significantly reduces the oxidation of biomass, minimizes the formation of undesirable volatile organic compounds, and enhances the thermal stability of the biomass, resulting in solid biomass fuels with higher energy density and improved storage properties. An embodiment of the invention includes the torrefaction module is includes an autothermal heating apparatus to efficiently heat and recover heat whilst processing the lignocellulosic biomass. The torrefaction apparatus may include, but is not limited to a multiple hearth furnace, wet torrefaction system, rotary furnace, or fluidized bed, and further includes a nitrogen supply system to enhance the nitrogen-enriched environment;
b. A carbonization module configured to further process the torrefied de-alkalized feedstock in an oxygen-depleted, nitrogen-enriched environment at temperatures ranging from 500° C. to 1,000° C., with a residence time between 60 minutes and 120 minutes. The nitrogen-enriched environment in the carbonization process further reduces the risk of combustion and unwanted chemical reactions, thereby preserving the carbon structure and enhancing the calorific value of the resulting solid biomass fuels. The carbonization apparatus may include but is not limited to a multiple hearth furnace, wet torrefaction system, rotary furnace, or fluidized bed reactor, and further includes a nitrogen supply system to enhance the nitrogen-enriched environment;
c. A heat recovery and autothermal heating module comprising of:
   i) Autothermal Heating Apparatus: A specialized component within the torrefaction module that utilizes the principle of autothermal reaction, where the heat generated from the partial combustion of biomass itself is used to sustain the torrefaction process. This approach reduces the need for external heat sources, thereby enhancing the energy efficiency of the process.
   ii) Heat Recovery Mechanism: Integrated with the autothermal heating apparatus, this mechanism captures excess heat generated during torrefaction and carbonization. The recovered heat is then used for pre-heating the de-alkalized feedstock entering the torrefaction module or for other energy-intensive processes within the system, such as drying the biomass before de-alkalization or powering auxiliary systems.
d. An artificial intelligence (AI) management system module: configured to control and optimize the processing parameters of the heat-treatment subsystem, torrefaction module, and carbonization module based on real-time feedstock characteristics, environmental conditions, and desired output properties of the solid biomass fuels.
e. Advanced Emission Control Module: An innovative system designed to capture and treat emissions from the torrefaction and carbonization processes, including volatile organic compounds (VOCs), particulate matter, and nitrogen oxides (NOx), thereby minimizing environmental impact and adhering to strict environmental regulations.

The invention, producing biogas from the recirculated water and water extracted during the pressing lignocellulosic material and collected in the treated water recirculation and treatment sub-system of the using a biogas production sub-system, comprising:
a. a treatment module configured to de-alkalize lignocellulosic feedstock, including but not limited to Empty Fruit Bunches (EFB) and flax fiber, utilizing a chemical, enzymatic, or microbial process, wherein said de-alkalization process is enhanced by micronizing the feedstock to significantly increase its surface area, thereby making it more amenable to enzymatic action and enhancing the accessibility of cellulose and hemicellulose components for subsequent anaerobic digestion, and producing a de-alkalized feedstock and treated water with a high biological oxygen demand (BOD) from the de-alkalization process;
b. an anaerobic digester unit into which said de-alkalized feedstock and said treated water are fed, the unit being specifically designed to operate under controlled positive pressure conditions created by a combination of biogas recirculation and controlled gas injection, which enhances the solubility of substrates in the feedstock mixture, thereby accelerating the anaerobic digestion process and increasing the overall yield of biogas by ensuring an optimal partial pressure of methane within the system;
c. a control system configured to dynamically adjust the positive pressure within the anaerobic digester unit based on real-time feedback regarding the composition of the de-alkalized feedstock and the treated water, and to adjust the pH of the treated water to an optimal range for anaerobic digestion before introduction into the digester, thus optimizing conditions for maximum biogas production;
d. a recirculation system designed to recycle a portion of the produced biogas back into the anaerobic digester unit, thereby maintaining the positive pressure conditions and a biogas purification system integrated to remove contaminants from the produced biogas, ensuring the quality of biogas for downstream applications;
e. the system further being configured to utilize the produced biogas to generate electricity, heat, or both, which are used to power the de-alkalization process and other operational needs of the system, thereby creating an autonomous energy loop that minimizes external energy dependency and enhances the sustainability of the biogas production process;
wherein the said system also includes the capability to utilize the de-alkalized feedstock not only for the production of biogas but also for the generation of biofuels, biochemicals, and bioproducts within an integrated production facility, leveraging the improved digestibility and reduced alkalinity of the feedstock for diversified bioenergy and bioproduct synthesis.

The invention generates carbon credits using a carbon credits and renewable energy certificates (RECs) sub-system configured to register and generate carbon based tradable credits, tax related incentives and RECS generated by the application of system and method, the sub-system comprises:
a. a production facility registration module to register the production facility to qualify for carbon credit generation;
b. A biogenic conversion accounting module, including but not limited to empty fruit bunches (EFB), is processed through the lignocellulosic heat treatment subsystem to produce a processed biobased product, wherein the processing facilitates biogenic sequestration of methane emissions by avoiding the decomposition of the material and release of methane, reduces greenhouse gas;
c. The biomass energy accounting module registers and quantifies the biomass-based power and biogas power generated from lignocellulosic material or de-alkalized lignocellulosic material as a fuel source;
d. a reduction of greenhouse gas emissions quantifying module resulting from the avoidance of carbon dioxide (CO2) and methane (CH4) emissions due to the biogenic sequestration of methane in the lignocellulosic material;
c. means for generating carbon credits and renewable energy certificates based on the quantified reduction of greenhouse gas emissions, wherein the carbon credits and RECs are directly associated with the processed product of the de-alkalization system;
f. means for converting the captured methane into a secondary product, thereby further reducing the greenhouse gas emissions associated with the lignocellulosic material; and
g. wherein the subsystem is designed to be adaptable to variations in the lignocellulosic material processed and the specific configurations of the de-alkalization system, ensuring the process qualifies for emission trading schemes due to the comprehensive greenhouse gas emission reduction.

In an embodiment of the invention, the system employs renewable energy by purchase or produced to operate the de-alkalization system and method using a renewable energy sub-system, comprising:
a. a scalable solar power module comprising photovoltaic cells arranged in an array, configured to convert solar energy into electrical energy and adjust the electrical output based on the energy requirements of the de-alkalization system;
b. a hydrogen fuel cell module configured to convert hydrogen into electrical energy, wherein the hydrogen is produced from the electrolysis of water using excess electrical energy generated by the solar power module;
c. a biomass conversion module configured to process lignocellulosic material and de-alkalized lignocellulosic material to generate electrical energy, which includes a gasification unit for converting lignocellulosic material into syngas, a combustion unit for burning syngas to generate electrical energy, and a pre-processing unit for treating the lignocellulosic material and de-alkalized lignocellulosic material to optimize their conversion into syngas;
d. a control unit equipped with a machine learning algorithm, configured to manage the operation of the solar power module, hydrogen fuel cell module, and biomass conversion module by predicting the availability of solar energy, hydrogen, and lignocellulosic materials, and dynamically adjusting the operation of the modules to maximize efficiency, minimize waste, and direct the generated electrical energy to power a de-alkalization system;
e. an energy storage unit comprising a combination of lithium-ion batteries and hydrogen storage tanks, configured to store excess electrical energy generated by the solar power module, hydrogen fuel cell module, and biomass conversion module for later use in powering the de-alkalization system, optimizing energy storage and release based on the operational requirements of the de-alkalization system.

In an embodiment of the inventions, renewable energy sub-system can sell energy it produces using any of the modules customers.

In another embodiment of the invention, the subsystem can utilize de-alkalized bioproducts to generate renewable energy.

The invention transports stores lignocellulosic material, de-alkalized lignocellulosic material and bioproducts using a bioproduct storage and transport subsystem, comprising:
a. a fleet of electric, hydrogen, biogas or biofuel trucks equipped with a power management system designed for long-haul transport for collection of lignocellulosic and for transportation of de-alkalized bio-products post-production;
b. custom-made container module configured to maintain bioproducts at specified conditions throughout transport, said containers being adaptable for loading, unloading, and securing within said electric trucks, wherein said containers are modular, allowing for the configuration of internal compartments to accommodate different types of bioproducts simultaneously, said compartments being individually controllable to maintain specific environmental conditions required by each bioproduct type;
c. a bulk handling system module integrated into said electric trucks and custom-made containers for transferring bioproducts between storage facilities and said containers, wherein the bulk handling system is operable to manage bioproducts in various states including solid, liquid, and gas;
wherein the subsystem is configured to coordinate transport logistics through a digital management platform module that optimizes routes based on energy consumption, bioproduct stability requirements, and delivery schedules; and
wherein the custom-made containers include sensors for real-time monitoring of bioproduct conditions and communicating said conditions to the digital management platform for ensuring product integrity during transport

It shall be noted that the present invention further provides a method of operating the system and further the apparatus. Any steps mentioned in the preceding description shall is part of a method for de-alkalizing a lignocellulose material using the system and apparatus.

Generally, the solid biofuel formed from the de-alkalized lignocellulosic feedstock obtained from the aforementioned system, apparatus and methods fulfills the Hargraves Grindability Index, i.e., an index requirement essential for using lignocellulosic material as a feedstock in existing coal-based processes. Depending on the method of processing (such as, torrefaction or carbonization), the solid biofuel generally have a fixed carbon content of at least 20%, a Lower Heating Value (LHV) of at least 5, and a HGI value of more than 35.

While specific embodiments have been described and illustrated, it is understood that many changes, modifications, variations and combinations of variations disclosed in the text description and drawings thereof could be made to the present invention without departing from the scope of the present invention.

1.-55. (canceled)

56. An apparatus for de-alkalinizing lignocellulosic material, comprising:
(a) a cooling vessel configured to reduce temperature of a slurry in the vessel to a temperature of 2 to 20° C.;
(b) a first set of ultrasonic flow cells located upstream to an ultrasonic enabled reactor vessel, preferably incorporating a helical flow cell vessel insert configured to transfer the slurry from the cooling vessel to the ultrasonic enabled reactor vessel along a helical pathway, wherein the ultrasonic flow cell subjects the slurry to a pressure of 0.1 to 20 MPa at an ultrasonic frequency range of 10 MHz to 50 MHz;
(c) the ultrasonic enabled reactor vessel comprising at least one ultrasonic device and a high-shear agitator having a rotor-stator assembly, wherein at least one of the ultrasonic devices is located in vicinity to the rotor-stator assembly to concentrate ultrasonic field frequency of 10 MHz to 50 MHz around the rotor-stator assembly;
(d) a second set of ultrasonic flow cells located downstream to the ultrasonic enabled reactor vessel, preferably incorporating a helical flow cell vessel insert configured to transfer the slurry from the ultrasonic enabled reactor vessel along a helical pathway, wherein the ultrasonic flow cell subjects the slurry to a pressure of 0.1 to 20 MPa at an ultrasonic frequency range of 10 MHz to 50 MHz;
(e) a flow-through hydrodynamic cavitation (FTHC) unit configured to transfer a slurry from the second set of ultrasonic flow cells while subjecting it to pressurization at about 0.1 to about 100 MPa thereby inducing hydrodynamic cavitation therein;
(f) a direct steam injection device connected downstream to the flow-through hydrodynamic cavitation unit, the direct steam injection device being configured to inject steam into a slurry at a temperature of up to 250° C. and pressure of up to 21 MPa;
(g) a network of reactor conduits configured to transport a heated slurry from the direct steam injection device therethrough under a pressure of up to 200° C. and pressures up 10 bars for a predetermined amount of time; and
(h) a heating vessel configured receive slurry from the reactor conduits and further provide heating up to 200° C. and agitation thereof.

57. The apparatus according to claim 56, wherein the ultrasonic enabled reactor vessel further connects to a supercritical fluid source.

58. The apparatus according to claim 56, wherein the direct steam injection includes a cylindrical vessel with a helical baffle within the vessel inlet pipe.

59. The apparatus according to claim 56, wherein the ultrasonic enabled reactor vessel comprises a plurality of ultrasonic devices, each of them is positioned at the reactor in a manner to provide a uniform ultrasonic field in the reactor, in which one of them is positioned at bottom of the reactor.

60. The apparatus according to claim 56, wherein the high-shear agitator comprises a motor, a rotor shaft and a rotor-stator assembly, wherein the rotor shaft includes at least a rotor blade.

61. The apparatus according to claim 60, wherein a stator of the rotor-stator assembly is configured with an extended skirt portion to connect with the ultrasonic device attached at the bottom of the reactor thereby transmitting ultrasonic emission from the ultrasonic device to the reactor.

62. The apparatus according to claim 61, wherein the high-shear agitator further comprises a stabilizing means with one side lying against the reactor and another side fastened to the stator, thereby stabilizing the agitator.

63. The apparatus according to claim 62, wherein the stabilizing means is configured as a channel in connection with the supercritical fluid source.

64. The apparatus according to claim 62, wherein the stabilizing means connects to the skirt portion of the stator and distributes the supercritical fluid in the reactor.

65. A method for producing de-alkalizing lignocellulosic material and bioproducts, comprising the steps of:
(a) reducing the size of the lignocellulosic material into particles;
(b) pre-treating the material using electromagnetic and electric field processes;
(c) forming a slurry by mixing the pre-treated material with a water mixture comprising chemical agents;
(d) subjecting the slurry to ultrasonic resonance and flow through cavitation in a pressurized environment with high-shear to induce hydrodynamic cavitation thereby cellular level disruption, enhancing extraction of alkali component from the slurry;
(e) subjecting the slurry to flow through cavitation in a pressurized environment with high-shear to induce hydrodynamic cavitation; and
(f) subjecting the slurry to direct steam injection to induce hydrostatic cavitation in the presence of rapid heating and cooling of the slurry material to enhance alkali neutralization;
(g) continuously monitoring and adjusting the process based on alkali levels;
(h) separating the slurry into solid de-alkalized material and treated water;
(i) washing the slurry to remove ionic waste and solid particles of larger than 1 micron from the slurry thereby obtaining a de-alkalized lignocellulosic material;
(j) recirculating separated treated water from the application of the process or using the separated treated water to make bioproducts; and
(k) subjecting the solid de-alkalized material to densification in order to produce a de-alkalized bioproducts.

66. The method according to claim 65, further comprising a step of collecting the lignocellulosic material, followed by washing, digesting and/or adding chemical agents to the collected lignocellulosic material before reducing them into particles.

67. The method according to claim 65, wherein the step of (d) is conducted in the presence of supercritical carbon dioxide.

68. The method according to claim 65, wherein the step of (d) is conducted under ultrasonic frequency range between 10 Hz to 50 MHz.

69. The method according to claim 65, wherein the step of (a) comprises the steps of: processing lignocellulosic material into particles having an average particle size of less than 10 mm.

70. The method according to claim 65, wherein the step of (b) comprises the steps of: (i) subjecting the particles to electromagnetic energy processing treatment at 500 to 5000 MHz; and (ii) subjecting the particles to pulsed electric field (PEF) provided by voltage pulses between 10 to 100 kV to obtain porous particles.

71. The method according to claim 65, wherein the step of (c) has a water mixture-to-particles ratio of 1:1 to 1:25.

72. The method according to claim 65, wherein the step of (f) is conducted heating the slurry with a direct steam injection at a temperature of 1° C. to 250° C. and a pressure of 0.01 MPa to 21 MPa.

73. The method according to claim 65, wherein the step of densification is conducted by drying and mixing the solid de-alkalized material with a binder and chemical agent, followed by compressing thereof.

74. The method according to claim 65, wherein the rapid cooling in the step of (f) is conducted at a pressure of 0.1 to 10 MPa and provides a cooling rate of 20° C. per minute or more.

75. The method according to claim 65, wherein the high shear environment of step (d) is a shearing speed of up to 5000 rpm.
